(19) United States
(12) Patent Application Publication
(10) Pub. No.: US 2014/0311011 A1
(43) Pub. Date: Oct. 23, 2014

(54) AUGER FISHING LURE

(71) Applicants: Walter Guntharp, Pendleton, IN (US); Vernon Smith, McCordsville, IN (US); Nicholas Adams, Fortville, IN (US)

(72) Inventors: Walter Guntharp, Pendleton, IN (US); Vernon Smith, McCordsville, IN (US); Nicholas Adams, Fortville, IN (US)

(21) Appl. No.: 13/865,305

(22) Filed: Apr. 18, 2013

(51) Int. Cl. A01K 85/12

(52) U.S. Cl. CPC A01K 85/12
USPC 43/42.09; 43/42.2

(57) ABSTRACT

An artificial fishing lure utilizes gyratory motion of a rotating auger of the lure to provide novel water dynamics while the lure is being pulled through the water in order to entice a fish to strike at the lure. The lure includes a shaft, a head on one end of the shaft, a tail on another end of the shaft, and the auger situated freely on the shaft between the head and the tail for rotation on and about the longitudinal axis of the shaft. The auger has one or more configured external blades along its length. The blade(s) provide a means that rotates the auger through water resistance as the lure is pulled through the water to thereby create novel and enhanced water dynamics.

### FIELD OF THE INVENTION

The present invention relates to artificial fishing lures and, more particularly, to artificial fishing lures using mechanical motion to enhance the attractiveness of the artificial lure to a fish.

### BACKGROUND

Many people fish as a recreational endeavor, as a sport or for commercial purposes. With all types of fishing, however, the fisherman has a choice of using natural or artificial bait. Because of various issues regarding the use of natural bait, a large number of fisherman use artificial bait or lures rather than natural bait for trying to catch fish. Artificial bait or lures are used for both fresh water fishing as well as salt water fishing

In all cases, the purpose of an artificial fishing lure is to trick a fish into wanting to eat the lure and get caught on a hook associated with or as part of the artificial lure. There are many types of artificial fishing lures such as jigs, surface lures (e.g. top water lures or poppers), spoons, plugs or crankbaits, spinnerbaits, as well as soft plastic lures shaped as a worm, grub, minnow, cricket, amphibian or similar natural fish-food. Each type is available in a variety of shapes, sizes and colors.

In addition to relying on the inherent characteristics of the type of artificial fishing lure, artificial fishing lures have been developed that add features such as sound, vibration, and/or light through various mechanical and/or electrical arrangements, since it is known that fish are attracted to flash, color and movement. While these arrangements augment their water dynamics, they do little in attracting fish. What is therefore needed is an artificial fishing lure having novel water dynamics that attract fish.

It is therefore an object of the present invention to overcome the shortcomings of the prior art by providing an artificial fishing lure having novel water dynamics for attracting fish.

### SUMMARY OF THE INVENTION

The present invention is an artificial fishing lure having a rotating auger which generates turbulence for attracting fish when the artificial fishing lure is pulled through the water.

The novel artificial fishing lure is characterized by an assembly having a shaft, a nose at one end of the shaft, a tail at the other end of the shaft, and an auger disposed for rotation on and about the shaft between the nose and the tail. These components may be made from various materials that are suitable for the manufacture of lures including, but not limited to, metal, fiberglass, carbon fiber, and plastic.

In one form, the nose, tail or both are configured to be removable from the shaft for replacement of the nose, tail or both, and/or for access to and/or replacement of the auger. In another form, one of the nose or tail is removable for replacement thereof and/or access to and/or replacement of the auger. In yet another form, the nose and tail are not removable.

The artificial fishing lure is designed with a longitudinal hole through the assembly so that a fishing line may be run through the assembly and a hook affixed to the rear. This allows the artificial fishing lure to be trolled or pulled through the water.

When the artificial fishing lure is pulled through the water, the auger freely rotates on and about the central shaft, creating novel and enhanced water dynamics by causing flash, turbulence, motion, and vibration. In order to accommodate these novel water dynamics, the blade or blades of the auger may be of a constant size (e.g. in diameter and/or thickness) along its length, may be increased or decreased in size along its length, or may be variable in size (e.g. in replicating the shape of a fish or other bait). The blade or blades of the auger may be solid, finned, or provided with holes to further enhance the water dynamics (e.g. turbulence) and/or other features of the present artificial fishing lure that attract fish.

The nose of the present artificial fishing lure may generally be any shape desired so as to mimic a particular type of bait and/or to change the performance of the lure. Primary shapes for the nose include bullet, cone, or “chug head”. The nose may be provided with offset spinners, in-line spinners, lips that cause the lure to dive, or other appurtenances that change the manner in which the lure travels through the water.

The longitudinal hole through the nose of the lure allows fishing line to be passed through the nose, into and out of the longitudinal hole of the shaft, and through the longitudinal bore of the tail so as to exit the rear of the lure. The longitudinal hole is of sufficient diameter to accommodate various sizes of fishing line without binding or restriction. The longitudinal hole through the nose may be directly through the center of the nose or may be offset from center so as to change the manner in which the fishing lure tracks through the water when pulled.

The nose may be made of metal, acrylic plastics, fiberglass, wood, carbon fiber, or any other material that is suitable for use as a salt-water and/or freshwater fishing lure and able to withstand the rigors of use. The nose may be fashioned with artificial eyes of various shapes or sizes in order to imitate a live fish. Holes, propellers, or off-set spinner blades that are affixed by a metal wire may also be applied to a nose.

The shaft of the present artificial fishing lure is characterized by a rod, bar or the like with the longitudinal hole extending through the shaft from one end to the other end. The shaft may also be a tube having a hollow interior. In either case, the center of the shaft is hollow so as to allow the passage of fishing line or wire through the longitudinal axis of the shaft. The nose is either permanently attached to or removably situated onto one end of the hollow rod while the tail is either permanently attached to or removably situated onto the other end of the hollow rod. The shaft is slightly smaller in diameter than the inner diameter of the auger. The shaft may be made of various materials including, but not limited to, metal, fiberglass, acrylic plastics, carbon fiber or the like. In the case where the nose and/or tail are removable from the shaft, the shaft, nose and tail may utilize screw threads, a groove that accommodates snap rings, or other securing devices.

Various tails may be attached to the shaft at the rear of the lure. The tails can include, but not be limited to, skirts of various sizes and length. Such skirts are designed to move in the water to better attract fish. The skirts may be made of mylar, plastic, nylon, rubber, or other natural or synthetic materials. The skirts or tails may be dyed or colored in various manners and may be made of multiple materials and in various lengths.

Alternatively, the tail may consist of a solid appurtenance that is shaped in a manner to attract fish. This shape shall include, but not be limited to, a solid tapered device, a device with a fish shaped tail, a flexible synthetic tail, or any other shape, provided that it provides accommodation for the attachment of a hook. The hook(s) may be affixed to the tail or tied to a line that is passed through the length of the lure. The tail may be solid, hollow, or a combination of both. Positioning of the tail serves to lock or hold the auger into place on the shaft between the nose and the tail, and prevent it from sliding off the rear of the lure.

The auger is characterized by a hollow tube having one or more blades on and/or about its exterior. The hollow tube is sized for reception onto and rotation about the shaft, particularly the longitudinal axis thereof The auger may be made of a solid or semi-flexible material and designed so that as the lure is pulled through the water, the auger rotates freely on the central shaft. The design of the auger may include a constant size from front to rear as well as shapes that include increase and decreasing diameters throughout the length of the auger. The center core of the auger is hollow in order to slide over the central shaft of the lure. The blades shall be solid or have holes therein that are designed to create additional turbulence and/or bubbling as the lure travels through the water.

The auger is constructed of a material that is sufficiently strong to withstand the strike of a fish. Such materials for construction shall include, but not be limited to, plastics, metals, rubber, or carbon fiber products.

It should be appreciated that the lure may be modified through the addition of various additional fish attractants including lips, in-line spinners, or off-set spinner blades. These items may be constructed of various materials as defined above.

Moreover, the present artificial fishing lure may be configured to accept liquid or solid scents to enhance the effectiveness of the lure. Such scents may be placed into a holder on the auger, nose or tail of the lure or affixed to it in such a manner as to not affect the action of the lure. In addition, “sparkles” that are held in a gel or otherwise affixed to the lure in a manner that allows them to be gradually released in such as way as simulate fish scales in the water may be added to the lure, particularly the auger.

### BRIEF DESCRIPTION OF THE DRAWINGS

The above mentioned and other features, advantages and object of this invention, and the manner of attaining them, will become apparent and the invention itself will be better understood by reference to the following description of embodiments of the invention taken in conjunction with the accompanying drawings, wherein:

FIG. 1 is a perspective view of an exemplary embodiment of an artificial fishing lure fashioned in accordance with the present principles;

FIG. 2 is an exploded perspective view of the artificial fishing lure of FIG. 1 illustrating the four components thereof;

FIG. 3 is a perspective view of a shaft of the artificial fishing lure of FIG. 1;

FIG. 3A is a sectional view of the shaft of FIG. 3 taken along line 3A-3A thereof;

FIG. 4 is a perspective view of an auger of the artificial fishing lure of FIG. 1;

FIG. 4A is a sectional view of the auger of FIG. 4 taken along line 4A-4A thereof;

FIG. 4B is a sectional view of the auger of FIG. 4, taken along line 4B-4B thereof;

FIG. 4C is a sectional view of the auger of FIG. 4 taken along line 4C-4C thereof;

FIG. 5 is a perspective view of a head of the artificial fishing lure of FIG. 1;

FIG. 5A is a rear end view of the head of FIG. 5 taken along line 5A-5A thereof;

FIG. 5B is a front end view of the head of FIG. 5 taken along FIG. 5B-5B thereof;

FIG. 6 is a perspective view of a tail of the artificial fishing lure of FIG. 1;

FIG. 7 is a side view of the present artificial fishing lure with a fishing line extending through the artificial fishing lure and carrying a fishing hook;

FIG. 8 is a perspective view of another embodiment of a head for the artificial fishing lure of FIG. 1;

FIG. 8A is a rear end view of the head of FIG. 8 taken along line 8A-8A thereof;

FIG. 8B is a front end view of the head of FIG. 8 taken along line 8B-8B thereof; and

FIG. 9 is a side view of a front portion of another embodiment of the present artificial fishing lure having a spinner on the nose thereof

Like reference numerals indicate the same or similar parts throughout the several figures.

A description of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION

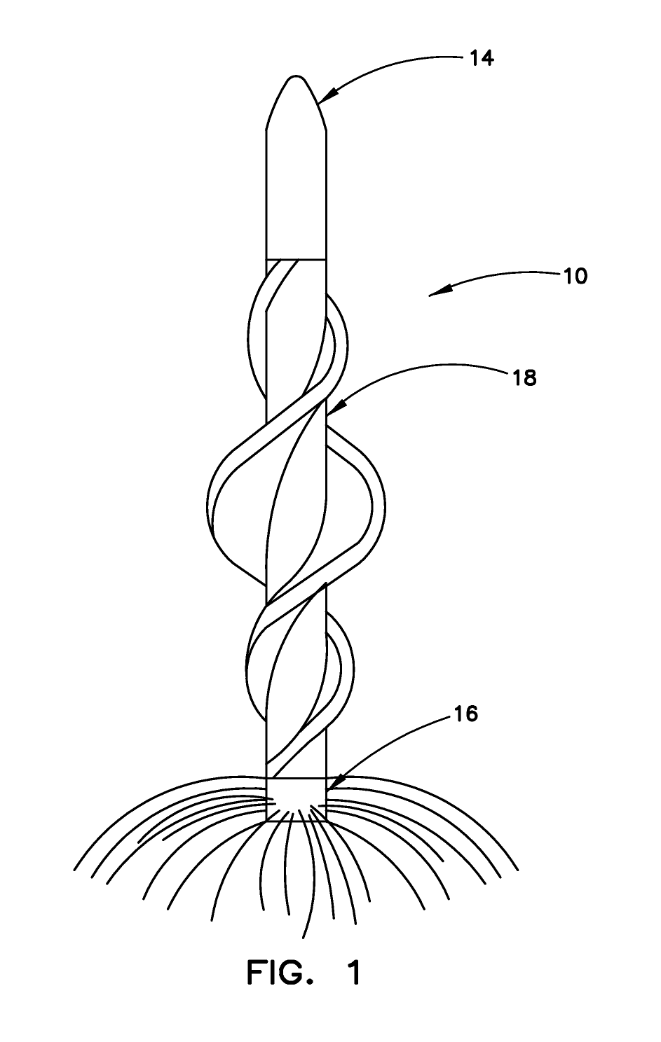

Referring to FIGS. 1-7, there is depicted an exemplary embodiment of an artificial fishing lure, generally designated 10, fashioned in accordance with the present principles. The artificial fishing lure 10 is designed for use in salt water or fresh water, and in various water columns including as a top-water lure through the use of appropriate formation materials.

The present artificial fishing lure 10 is shown in perspective in FIG. 1. In general, the fishing lure 10 is characterized by a shaft 12, a nose 14, a tail 16, and an auger 18, the auger 18 being disposed on the shaft 12 so as to freely rotate on and about the longitudinal axis of the shaft. In one form, and as depicted in FIGS. 1-9 and described below, the fishing lure 10 is made to be assembled and disassembled in order to replace or change one or more components of the fishing lure 10. In another form, one or more components of the fishing lure are not removable from one or more of the other components of the fishing lure.

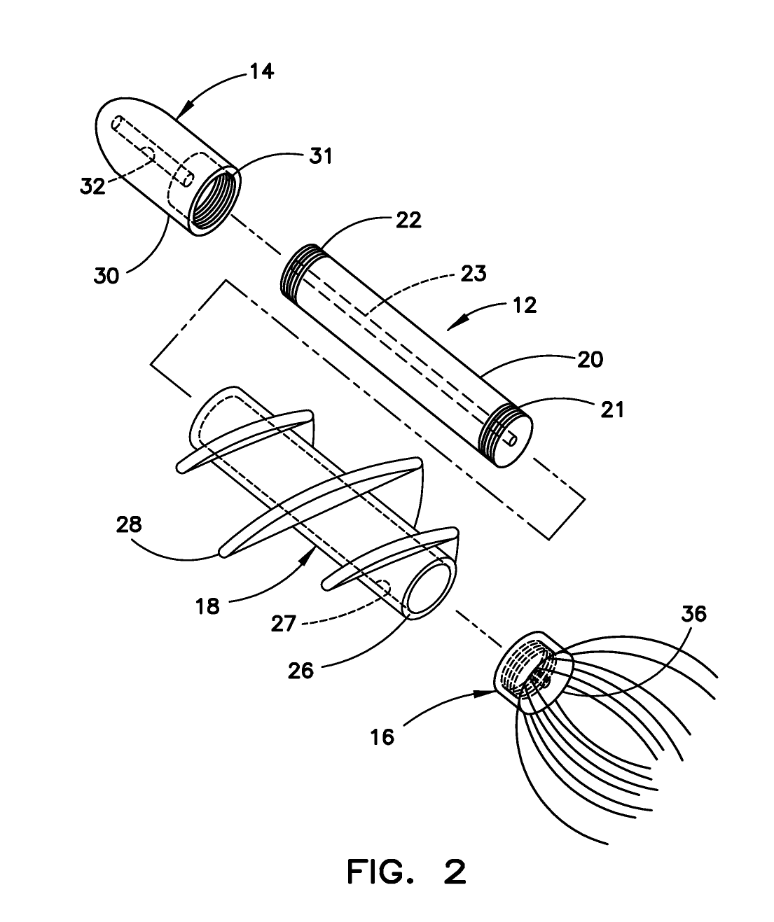

The fishing lure 10 is shown in an exploded view in FIG. 2 depicting the nose 14 unthreaded from a front threaded end 22 of the shaft 12, the auger 18 removed from the shaft 12, and the tail 16 unthreaded from a rear threaded end 21 of the shaft 12. It should be appreciated that, while not shown, other manners of connecting the nose to the shaft and the tail to the shaft may be used.

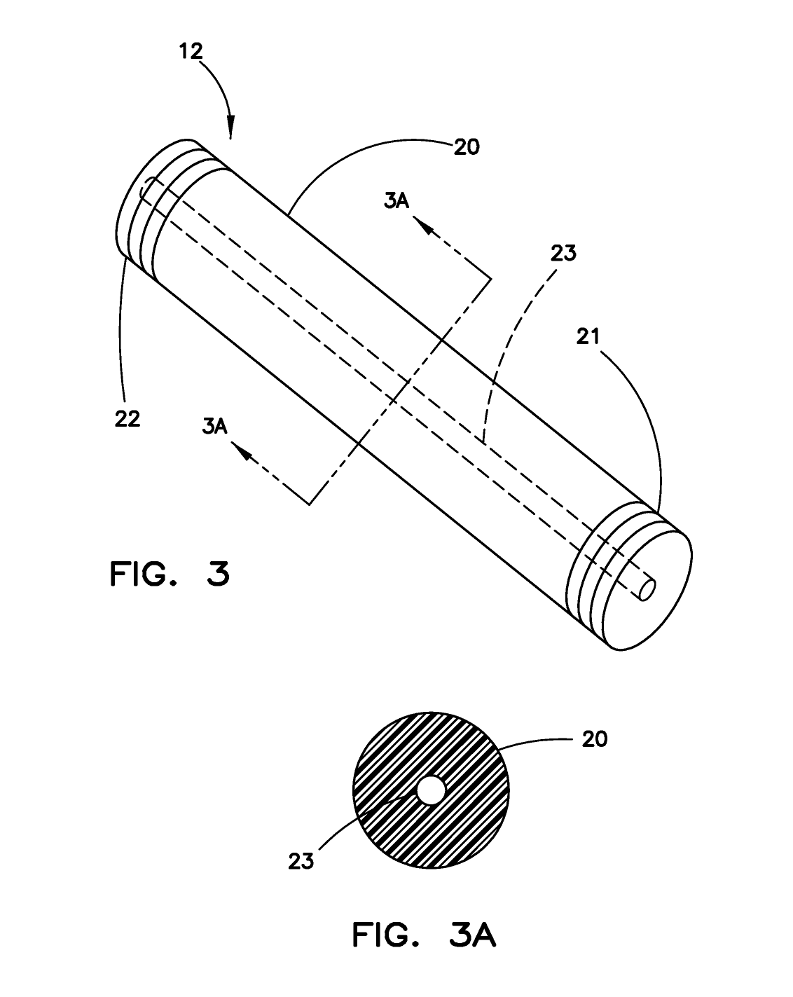

As best seen in FIGS. 3 and 3A, the shaft 12 is characterized by a longitudinal rod, tube, bar, or the like 20. The body 20 has a longitudinal hole or bore 23 extending from one end of the body to the other. The hole is sized to allow a fishing line, wire or the like to extend through the body 20. It should be appreciated that instead of the hole 23, the body 20 may be more or less hollow or otherwise to allow a line to extend therethrough. The rear end 21 of the body 20 as well as the front end 22 of the body has external threading. The front end threading is configured to receive the nose 14 while the rear end threading is configured to receive the tail 16.

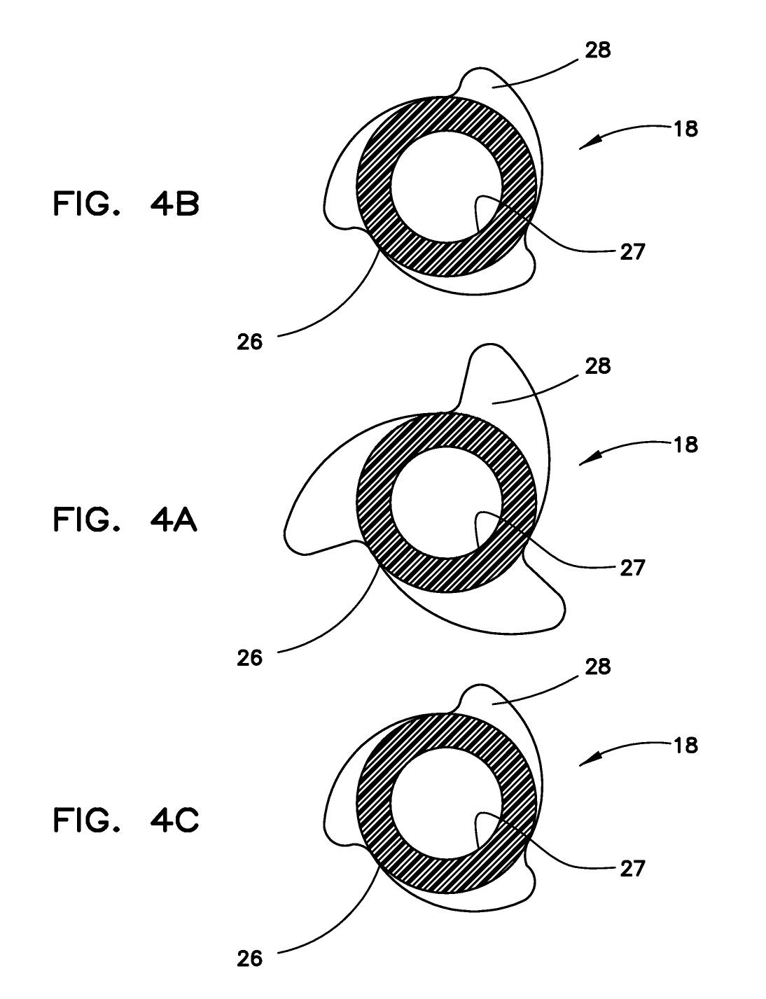

Referring to FIGS. 5, 5A and 5B, the nose 14 is particularly shown. The nose 14 has a generally bullet or conical shaped body 30 having a front tip and a rear threaded socket 31 sized and configured to threadedly receive the threaded front end 22 of the shaft 12. A bore or hole 32 extends through the body 30 from the apex of the front tip to the rear end, particularly into the socket 31 to allow a line to extend therethrough. As discerned in the figures, the hole 32 extends through the body 30 centered along its longitudinal axis. This lets the nose and thus the lure to track straight through the water when it is being pulled.

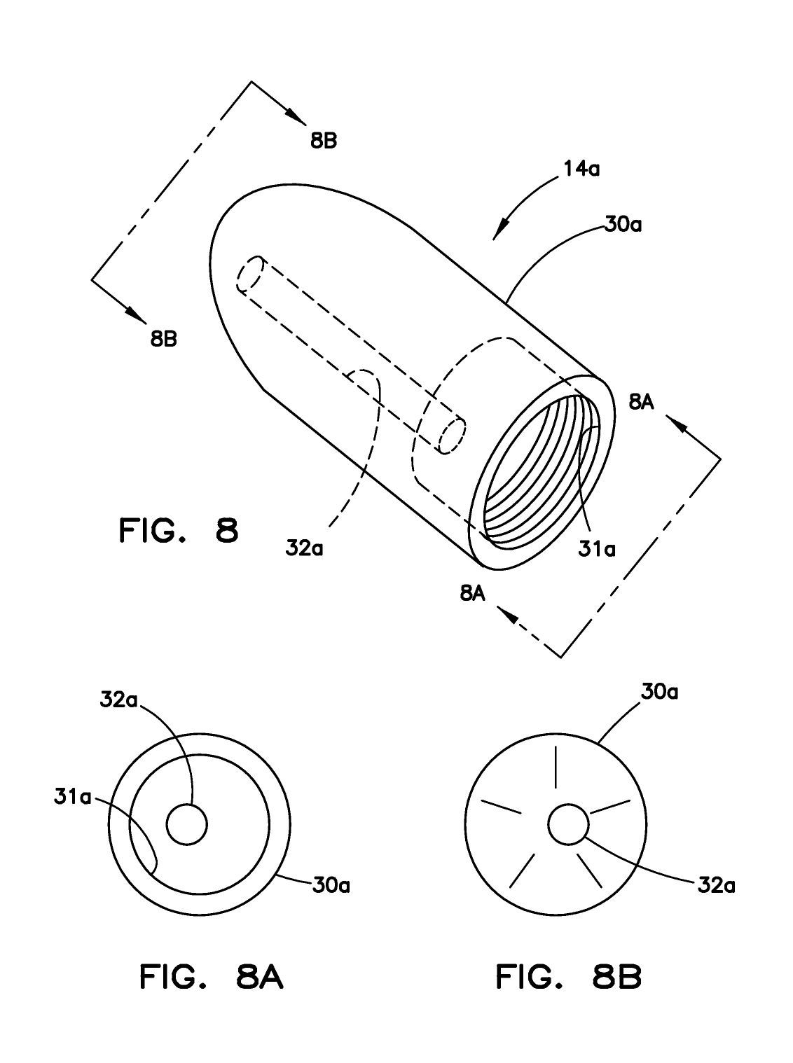

FIGS. 8, 8A and 8B, provide an alternative nose embodiment 14a wherein the nose hole 32a, while still being longitudinal and straight, extends off-center from the apex of the front tip to the socket 31 in order to allow a line to extend therethrough. In this embodiment, because the hole 32a is off-center from the apex, the nose 14a will not track straight as it is pulled through the water.

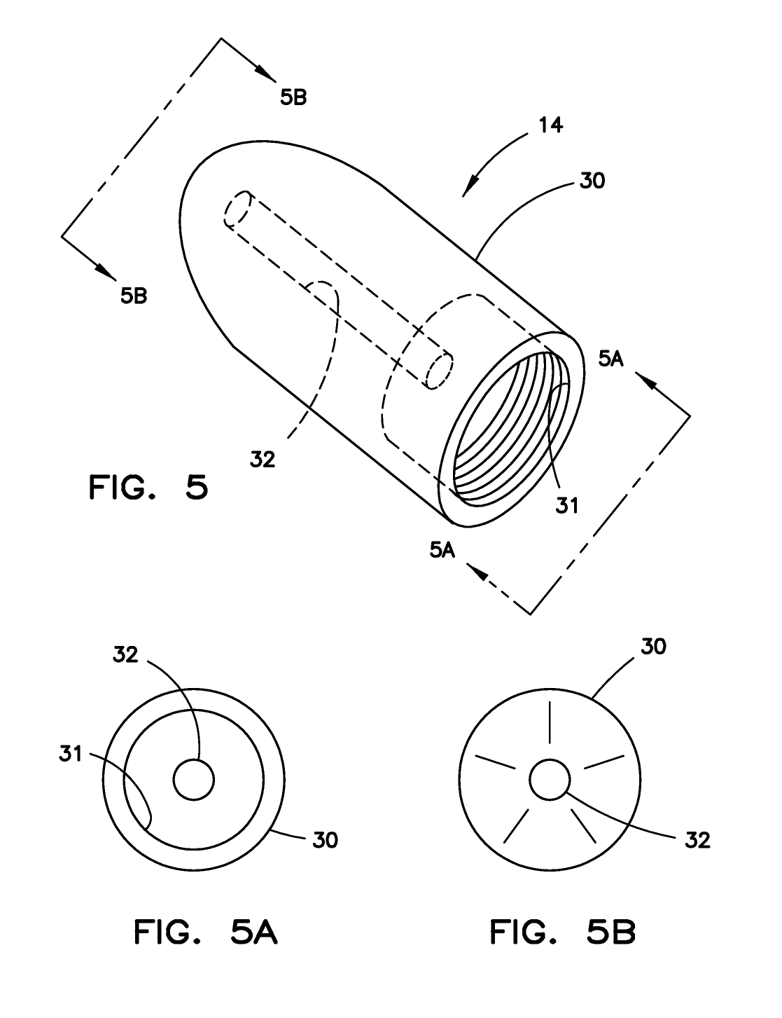

Referring now to FIG. 6, the tail 16 is particularly shown. The tail 16 is defined by a generally disk-shaped body 36 having a front threaded socket 37 sized and configured to threadedly receive the threaded rear end 21 of the shaft 12. A bore or hole 38 longitudinally extends through the body 36 from the front end to the rear end to allow a line to extend therethrough. While not necessary, the bore 38 extends through the body 36 centered along its longitudinal axis. The tail 16 also includes a skirt 39 that extends from the body 36.

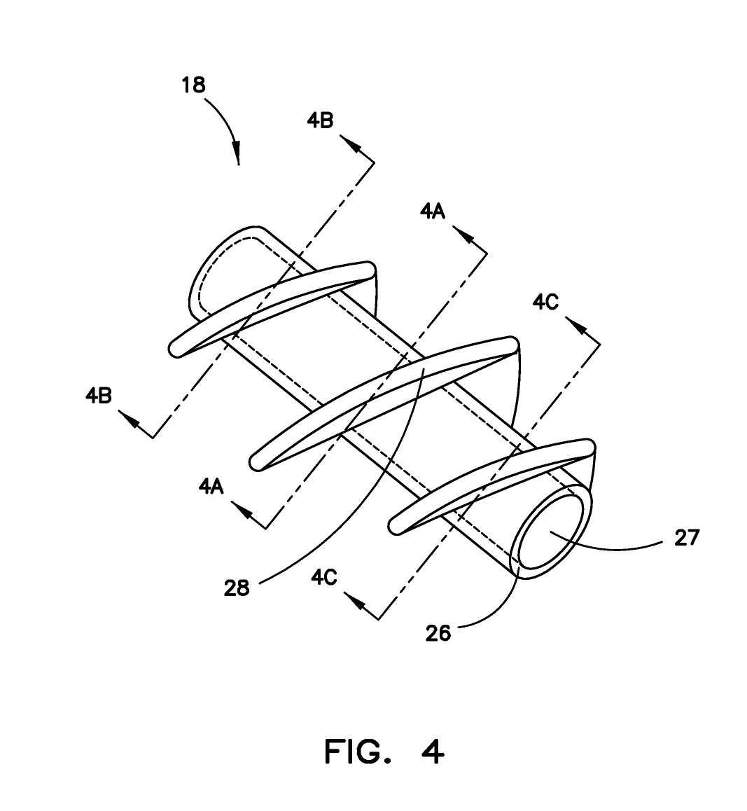

Referring now to FIGS. 4, 4A, 4B and 4C, the auger 18 is particularly shown. The auger 18 has a generally tubular body 26 having a longitudinal bore 27 extending through the auger. The diameter of the bore 27 is larger than the diameter of the shaft 12 in order for the auger 18 to slide over and onto the shaft 12. Preferably, but not necessarily, the inner diameter of the bore 27 is only slightly larger than the outer diameter of the shaft 12 in order to provide stable and reliable rotation of the auger 18 on the shaft 12.

The auger body 26 has an external, generally helical blade or flighting 28 that extends from a first or front end of the auger body 26 to a second or rear end of the auger body 26 and about its longitudinal axis. While as stated above, the external blade of the auger may take many forms, including dimensions such as blade height, blade shape, the presently preferred blade configuration is what is depicted in the figures. Particularly, the height of the helical blade 28 varies between the two ends of the auger body 26. More particularly, the height of the blade is larger at or approximate the center or midpoint of the lure (see sectional FIG. 4A taken along a center or midpoint of the lure body 26) relative to the ends of the auger (see sectional 4B taken along the front end of the auger body 26, and sectional 4C taken along the rear of the auger body). This auger configuration has been found to provide enhanced water dynamics such as turbulence as well as providing exceptional auger rotation. However, other auger configurations may be used.

While not shown, it should be appreciated that the auger may have more than one external blade. Moreover, if desired, the external blade or blades may have a shape that is not helical and/or a combination of helical and non-helical blades. Also, while the height of the blade 28 (the outer diameter of the auger) of the present lure is shown as variable, the blade height may be constant along the length of the auger body 26 or may be tapered along the length of the auger body 26 so that the outer diameter increases (or decreases) along its length. Many variations are contemplated including, but not limited to, color, blade shape and pitch, size, and/or length.

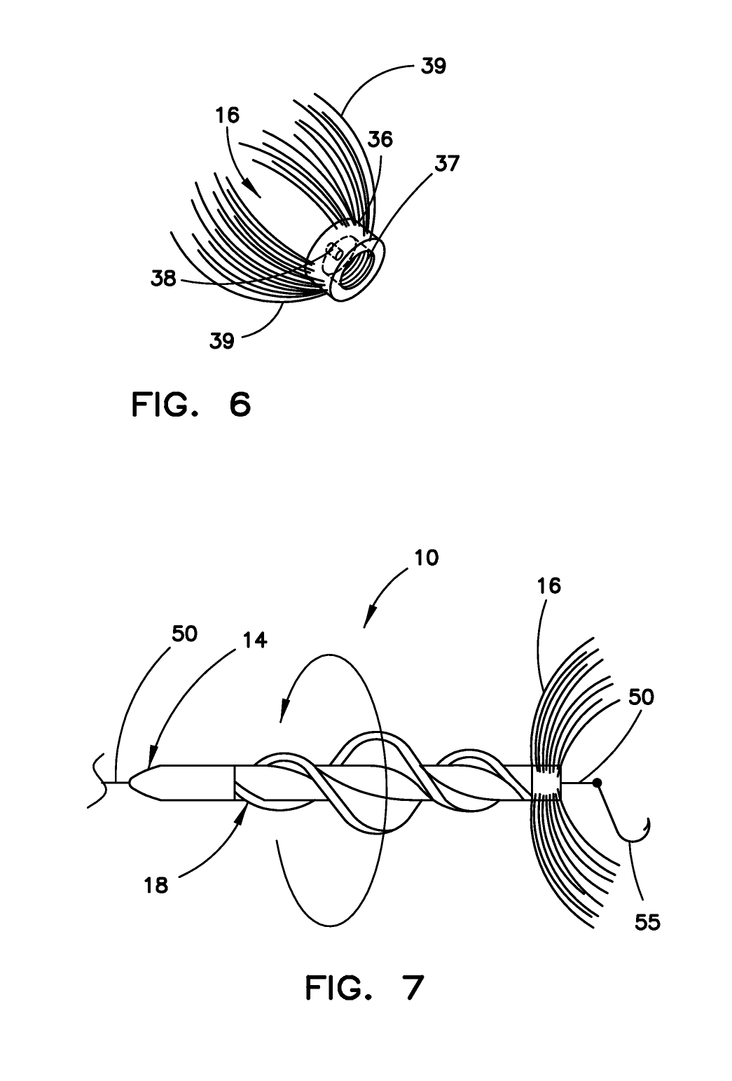

FIG. 7 depicts the artificial fishing lure 10 as it is being towed through the water with a fishing line 50 strung through the assembly, extending from the tail 16, and tied to a fishing hook 55. As the fishing lure 10 is being towed through the water, the auger 18 rotates on the shaft 12 between the nose 14 and the tail 16 (as represented by the arrow) producing novel water dynamics for attraction of fish. Changing the characteristics of the auger 18 by providing augers having more than one helical blade, or augers having one or more blades that are non-helical create different novel water dynamics. Color, size and shape of the blades/auger also create different novel water dynamics.

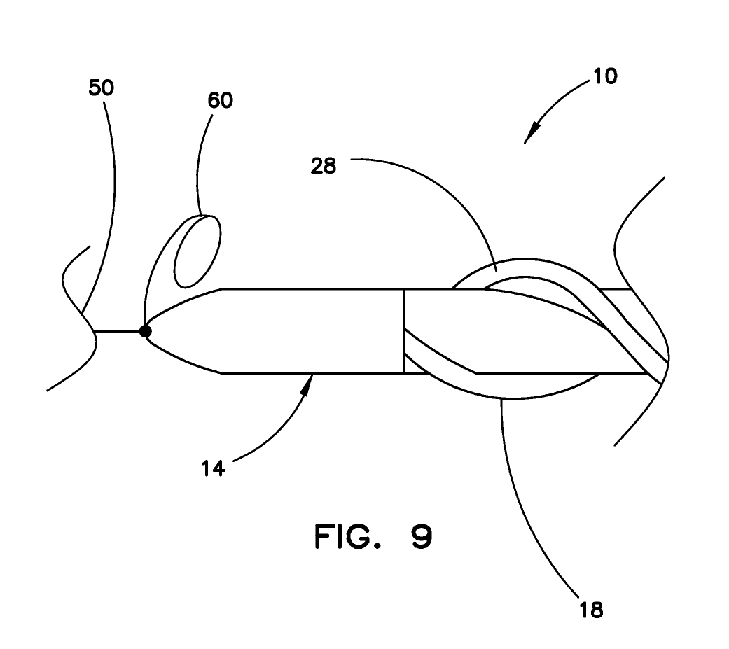

FIG. 9 depicts a front portion of another embodiment of the present artificial fishing lure 10 wherein a spinner 60 has been added as an appurtenance to the nose 14. A fishing line 50 is connected to the front tip of the nose 50 for towing the lure 10 through the water.

It should be appreciated that the present artificial fishing lure may take many shapes and be designed to operate in salt or fresh water and/or in various water columns. However, the central actuation is the auger that comprises the central body of the lure. The rigid or semi-rigid auger provides motion and attraction in a new and novel manner that has not been used in any prior fishing lures.

While the invention has been illustrated and described in detail in the foregoing drawings and description, the same is to be considered as illustrative and not restrictive in character. Those of skill in the art will understand that various details of the invention may be changed without departing from the spirit and scope of the invention. Therefore, it should be understood that only illustrative embodiments thereof have been show and described and that all changes and modifications that are within the scope of the following claims are desired to be protected. Moreover, the nomenclature first and second is arbitrary.

What is claimed is:

1. A fishing lure comprising:
a shaft having a first end and a second end;
a nose on the first end of the shaft;
a tail on the second end of the shaft; and
an auger freely situated on the shaft between the nose and the tail, the auger configured for rotation about the shaft as the fishing lure is pulled through water.

2. The fishing lure of claim 1, wherein the auger has an external helical blade that extends between ends of the auger.

3. The fishing lure of claim 2, wherein height of the external helical blade varies between the ends of the auger.

4. The fishing lure of claim 3, wherein height of the external helical blade is greater around a midpoint of the auger than at the ends of the auger.

5. The fishing lure of claim 4, wherein height of the external helical blade tapers from the midpoint of the auger to the ends of the auger.

6. The fishing lure of claim 2, wherein height of the external helical blade is constant between the ends of the auger.

7. The fishing lure of claim 2, wherein height of the external helical blade increases between the ends of the auger.

8. The fishing lure of claim 2, wherein:
at least one of the nose and tail are configured for removal from the shaft; and
the auger is configured for removal from the shaft.

9. An artificial fishing lure comprising:
a rod having a first end and a second end;
a nose having a front apex and situated on the first end of the rod;
a tail having a back end and situated on the second end of the rod; and
an auger situated on the rod between the nose and the tail and having an external helical blade extending about its length, the auger configured for free rotation about the rod as the fishing lure is pulled through water.

10. The artificial fishing lure of claim 9, wherein height of the external helical blade varies between ends of the auger.

11. The artificial fishing lure of claim 10, wherein height of the external helical blade is greater around a midpoint of the auger than at the ends of the auger.

12. The artificial fishing lure of claim 10, wherein height of the external helical blade tapers from the midpoint of the auger to the ends of the auger.

13. The artificial fishing lure of claim 9, wherein height of the external helical blade is constant between the ends of the auger.

14. The artificial fishing lure of claim 9, wherein height of the external helical blade increases between the ends of the auger.

15. The artificial fishing lure of claim 9, wherein:
at least one of the nose and tail are configured for removal from the rod; and
the auger is configured for removal from the rod.

16. An artificial fishing lure comprising:
a shaft having a first end and a second end;
a nose disposed at the first end of the shaft;
a tail disposed at the second end of the shaft;
one of the tail and the nose being removable from the shaft; and
an auger disposed for free rotation about a longitudinal axis of the shaft between the nose and the tail, the auger having an external helical blade extending that rotates the auger as the fishing lure is pulled through water.

17. The artificial fishing lure of claim 16, wherein height of the external helical blade varies between ends of the auger.

18. The artificial fishing lure of claim 17, wherein height of the external helical blade is greater around a midpoint of the auger than at the ends of the auger.

19. The artificial fishing lure of claim 16, wherein height of the external helical blade is constant between the ends of the auger.

20. The artificial fishing lure of claim 16, wherein height of the external helical blade increases between the ends of the auger.
